(19) United States
(12) Patent Application Publication
(10) Pub. No.: US 2026/0210643 A1
(43) Pub. Date: Jul. 23, 2026

(54) HEAT DISSIPATION APPARATUS

(71) Applicant: KMW INC., Hwaseong-si (KR)

(72) Inventors: Keum Hwan LEE, Busan (KR); Kyo Sung JI, Hwaseong-si (KR); Jin Kook SEO, Busan (KR); Chi Back RYU, Hwaseong-si (KR); Kyu Chul CHOI, Osan-si (KR); Dong Won KIM, Bucheon-si (KR); Hyun Gyu KANG, Osan-si (KR); In Hwa CHOI, Yongin-si (KR)

(73) Assignee: KMW INC., Hwaseong-si (KR)

(21) Appl. No.: 19/572,721

(22) Filed: Mar. 19, 2026

Related U.S. Application Data
(63) Continuation of application No. PCT/KR2024/014140, filed on Sep. 20, 2024.

(30) Foreign Application Priority Data
Sep. 20, 2023 (KR) 10-2023-0125690
Sep. 27, 2023 (KR) 10-2023-0130265
Oct. 31, 2023 (KR) 10-2023-0147806
Nov. 2, 2023 (KR) 10-2023-0149576
Sep. 19, 2024 (KR) 10-2024-0126699

(51) Int. Cl. F28D 15/02; F28F 21/08

(52) U.S. Cl. CPC F28D 15/0266; F28F 21/083; F28F 21/085; F28F 2275/04

(57) ABSTRACT

A heat dissipation apparatus according to the present invention includes: a first-side heat-conducting panel provided as a metal panel member; and a second-side heat-conducting panel provided as a metal panel member, wherein the first-side heat-conducting panel and the second-side heat-conducting panel have bent edge portions that are surface-bonded to each other to define a refrigerant flow space in which a refrigerant flows while undergoing phase change, and wherein the bent edge portion of one of the first-side heat-conducting panel and the second-side heat-conducting panel is arranged such that at least a portion thereof overlaps in a thickness direction of the refrigerant flow space with the bent edge portion of the other so as to enable the mutual surface bonding, thereby providing the advantages of maximizing heat dissipation performance and preventing injury to workers during product manufacturing.

### TECHNICAL FIELD

The present disclosure relates to a heat dissipation apparatus, and more particularly, to a heat dissipation apparatus, which is designed to prevent a change in the volume of a refrigerant flow space despite a change in internal pressure within the refrigerant flow space during a phase change of a refrigerant, which is a phase change material, and to enable a condensed liquid refrigerant to be uniformly collected in a direction of gravity, thereby maximizing heat dissipation performance, and which forms a sharp edge portion to be rounded, thereby preventing injury to a worker, and also improving product productivity.

### BACKGROUND ART

In various industrial fields such as communications, electronics, and electricity, related technologies are continuously being developed to a high level for application to more advanced industries. In order to develop highly advanced technologies, high-output energy is required, and devices that use high-output energy inevitably face the problem of high heat generation. Thus, the development of a cooling system at an appropriate level should be accompanied therewith.

The cooling system is used in various industries, including air conditioners, mobile communications, data centers, air mobility, electric vehicles, energy storage devices, and displays. Such a cooling system is one of the major causes of power consumption, and the power consumption is gradually increasing as industries continue to develop.

In general, a cooling device may be broadly classified into an active cooling device and a passive cooling device. The active cooling device mainly utilizes forced convection generated by a fan, whereas the passive cooling device may be classified as a technology that utilizes natural convection without using a fan.

However, a conventional cooling system has limitations in dissipating a high level of heat generated by continuously developing and advanced technologies. Thus, there is a need in related industrial fields for innovative technologies capable of solving these problems, and as part of efforts to solve them, heat dissipation apparatuses are being developed.

A phase change refers to a change in the inherent state of liquid, gas, or solid when it accumulates a large amount of energy or releases stored thermal energy.

The phase change refers to a change in the physical arrangement of molecules rather than a chemical reaction such as chemical bonding or formation. The heat in a state in which no phase change occurs when energy is applied to a substance is referred to as sensible heat, whereas the heat used during a phase change is referred to as latent heat.

However, the heat dissipation apparatus has a problem in that pressure increases as temperature rises, because temperature and pressure are proportional to each other. When pressure increases due to high temperature conducted from a heating element within the sealed heat dissipation apparatus, it may cause the heat dissipation apparatus itself to rupture. To address this problem, it is necessary to prevent the pressure from increasing, and the heat dissipation apparatus requires a sufficient internal volume to allow pressure equilibrium to be achieved during the phase-change circulation process of a substance.

### DISCLOSURE

### Technical Problem

The present disclosure is proposed to resolve the aforementioned technical issues and is directed to providing a heat dissipation apparatus that can maximize heat dissipation performance.

In addition, the present disclosure is directed to providing a heat dissipation apparatus that can minimize injury to a worker during the manufacturing of a product.

Further, the present disclosure is directed to providing a heat dissipation apparatus that can prevent injury to an installation worker.

Technical issues of the present disclosure are not limited to the technical issues mentioned above, and other technical issues not mentioned above will be clearly understood by those skilled in the art from the following description.

### Technical Solution

A heat dissipation apparatus according to an embodiment of the present disclosure includes a first-side heat-conducting panel provided as a metal panel member, and a second-side heat-conducting panel provided as a metal panel member, the first-side heat-conducting panel and the second-side heat-conducting panel have bent edge portions that are surface-bonded to each other to define a refrigerant flow space in which a refrigerant flows while undergoing phase change, and the bent edge portion of one of the first-side heat-conducting panel and the second-side heat-conducting panel is arranged such that at least a portion thereof overlaps in a thickness direction of the refrigerant flow space with the bent edge portion of the other so as to enable the mutual surface bonding.

The edge portion of the first-side heat-conducting panel and the edge portion of the second-side heat-conducting panel each may be bent in a direction forming a thickness of the refrigerant flow space.

The bent edge portion of the first-side heat-conducting panel may be a first-side thickness-forming panel forming a portion of the thickness of the refrigerant flow space, and the bent edge portion of the second-side heat-conducting panel may be a second-side thickness-forming panel forming a portion of the thickness of the refrigerant flow space.

A heat dissipation apparatus according to another embodiment of the present disclosure includes a first-side heat-conducting panel provided as a metal panel member, and a second-side heat-conducting panel provided as a metal panel member, the first-side heat-conducting panel and the second-side heat-conducting panel have bent edge portions that are surface-bonded to each other to define a refrigerant flow space in which a refrigerant flows while undergoing phase change, and the bent edge portion of one of the first-side heat-conducting panel and the second-side heat-conducting panel is arranged such that at least a portion thereof overlaps with the bent edge portion of the other on an outer side in a thickness direction of the refrigerant flow space so as to enable the mutual surface bonding.

A thickness-forming panel may be orthogonally bent and provided at the edge portion of the second-side heat-conducting panel, which is an insertion target among the first-side heat-conducting panel and the second-side heat-conducting panel, and a bonding portion bent to contact an inner side of a front end of the thickness-forming panel of the second-side heat-conducting panel may be formed at the edge portion of the first-side heat-conducting panel, which is inserted among the first-side heat-conducting panel and the second-side heat-conducting panel.

A contact surface portion may be further processed and formed at an edge portion of the first-side heat-conducting panel that is inserted into a press-fit portion having a slot-shaped press-fit slot disposed to transfer heat generated from heat-generating elements, such that the contact surface portion protrudes outward of the refrigerant flow space to contact an inner surface of the press-fit portion.

The contact surface portion formed on the first-side heat-conducting panel may be formed to be spaced apart from the bonding portion.

A plurality of strength reinforcing portions recessed toward the refrigerant flow space may be further formed on the first-side heat-conducting panel and the second-side heat-conducting panel, and the contact surface portion may be formed to protrude in a direction opposite to the plurality of strength reinforcing portions formed on the first-side heat-conducting panel.

When an end of each of the first-side heat-conducting panel and the second-side heat-conducting panel that are relatively close to the heat-generating elements generating and supplying predetermined heat is defined as an evaporation end, and portions other than the evaporation end are defined as a condensation end, the heat dissipation apparatus may further include a plurality of condenser sintered columns disposed on the refrigerant flow space and configured to guide flow of liquid refrigerant condensed at the condensation end, excluding the evaporation end of the first-side heat-conducting panel and the second-side heat-conducting panel installed at the press-fit portion, toward the evaporation end.

The plurality of condenser sintered columns may be installed in the refrigerant flow space via an evaporator sintered base connecting one ends thereof.

A plurality of column support protrusions supporting installation of the plurality of condenser sintered columns may be further formed on the first-side heat-conducting panel and the second-side heat-conducting panel, and the contact surface portion may be formed to protrude in a direction opposite to the plurality of column support protrusions formed on the first-side heat-conducting panel.

A heat dissipation apparatus according to another embodiment of the present disclosure includes a first-side heat-conducting panel provided as a metal panel member, and a second-side heat-conducting panel provided as a metal panel member and forming, together with the first-side heat-conducting panel, a refrigerant flow space in which a refrigerant flows while undergoing phase change, the second-side heat-conducting panel includes a second-side thickness-forming panel bent to be inserted into the first-side heat-conducting panel, a front end of which is bonded while being concealed from the outside by the first-side heat-conducting panel.

The first-side heat-conducting panel may include a first-side thickness-forming panel bent and formed orthogonally so as to be surface-bonded to the second-side thickness-forming panel of the second-side heat-conducting panel.

An outer surface of the second-side heat-conducting panel and a front end of the first-side thickness-forming panel of the first-side heat-conducting panel may be formed to match each other.

The second-side thickness-forming panel of the second-side heat-conducting panel may be bent to have a rounded shape with a predetermined radius with respect to the outer surface of the second-side heat-conducting panel, such that a filler material application gap is defined between the second-side thickness-forming panel and the front end of the first-side thickness-forming panel of the first-side heat-conducting panel.

The filler material application gap may be defined as a gap between the front end of the first-side thickness-forming panel, which is bent perpendicularly with respect to an outer surface of the first-side heat-conducting panel, and the outer surface of the second-side heat-conducting panel.

A filler material that melts at or above a predetermined melting point may be applied to the filler material application gap.

The filler material, after being applied to the filler material application gap, may bond the first-side heat-conducting panel and the second-side heat-conducting panel by a brazing welding process.

The first-side heat-conducting panel and the second-side heat-conducting panel may be provided as metal panel members made of SUS.

The first-side heat-conducting panel and the second-side heat-conducting panel may be stacked and bonded by a laser welding method or a brazing welding method.

The plurality of condenser sintered columns and the evaporator sintered base may be formed by sintering powder of SUS.

The plurality of condenser sintered columns and the evaporator sintered base may be formed by sintering metal powder having the same material as that of the metal panel members of the first-side heat-conducting panel and the second-side heat-conducting panel.

A material of the metal powder of the plurality of condenser sintered columns and the evaporator sintered base may be SUS.

The evaporator sintered base may be formed by sintering metal powder made of copper (Cu).

The first-side heat-conducting panel and the second-side heat-conducting panel may be made of the same metal material or different metal materials having a thermal conductivity equal to or greater than a predetermined level.

The first-side heat-conducting panel and the second-side heat-conducting panel may be sheet-metal processed through a press forming process.

### Advantageous Effects

A heat dissipation apparatus according to an embodiment of the present disclosure can achieve various effects as follows.

First, the present disclosure has an effect of significantly improving overall heat dissipation performance by dissipating system heat through a process in which a refrigerant filled therein undergoes a phase change.

Second, the present disclosure has an effect of significantly improving the productivity of a product by easily forming a refrigerant flow space, in which a refrigerant is filled, by bonding two metal panel members through a laser welding process or a brazing welding process.

Third, the present disclosure has an effect of improving work safety by preventing injury to a worker through a sharp edge portion by forming the sharp edge portion of the product to be rounded during manufacturing of the product.

### DESCRIPTION OF DRAWINGS

FIG. 1 is a perspective view illustrating a state in which a heat dissipation apparatus according to the present disclosure is installed in a press-fit portion of a housing body;

FIG. 2 is a cross-sectional view taken along line A-A of FIG. 4 and a partially enlarged view thereof, showing a heat dissipation apparatus according to a first embodiment of the present disclosure;

FIG. 3 is an exploded perspective view of FIG. 1, showing a heat dissipation apparatus according to a modification of the first embodiment of the present disclosure;

FIG. 4 is a front view of FIG. 1;

FIG. 5 is a cross-sectional view taken along line A-A of FIG. 4 and a partially enlarged view thereof ;

FIG. 6 is a perspective view illustrating a heat dissipation apparatus according to a second embodiment of the present disclosure;

FIG. 7 is an exploded perspective view of FIG. 6;

FIG. 8 is a front view of FIG. 6;

FIGS. 9A and 9B are cross-sectional views taken along lines B-B and C-C of FIG. 8, respectively, and partially enlarged views thereof;

FIG. 10 is a perspective view illustrating an application example of a heat dissipation apparatus according to a third embodiment of the present disclosure;

FIG. 11 is a perspective view illustrating a heat dissipation apparatus according to the third embodiment of the present disclosure;

FIG. 12 is an exploded perspective view of FIG. 11;

FIG. 13 is a front view of FIG. 11;

FIG. 14 is a cross-sectional view taken along line D-D of FIG. 13 and a partially enlarged view for explaining a bonded state by a filler material; and

FIG. 15 is an exploded cross-sectional view taken along line D-D of FIG. 13 and a partially enlarged view for explaining a bonded state by a filler material.

### DESCRIPTION OF REFERENCE NUMERALS

200: Heat dissipation apparatus (first embodiment) 200A: First-side heat-conducting panel
200B: Second-side heat-conducting panel 200A-P: (First-side) thickness forming panel
200B-P: Second-side thickness forming panel 220: Contact surface portion
240W: Contact portion 201: Evaporation end
203: Condensation end 205: Refrigerant flow space
230: Strength reinforcing portion 235: Column support protrusion
250: Condenser sintered column 251: Support protrusion
255: Evaporator sintered base 290: Air vent tube
295: Air vent hole 1200: Heat dissipation apparatus (second embodiment)
1200A: First-side heat-conducting panel 1200B: Second-side heat-conducting panel
1201: Evaporation end 1203: Condensation end
1205: Refrigerant flow space 1220: Contact surface portion
1230: Strength reinforcing portion 1235: Column support protrusion
1240W: Bonding portion 1250: Condenser sintered column
1255: Evaporator sintered base 2200: Heat dissipation apparatus (third embodiment)
2200A: First-side heat-conducting panel 2200B: Second-side heat-conducting panel
2201: Evaporation end 2203: Condensation end
2205: Refrigerant flow space 2210: Filler material application gap
2220: Filler material 2230: Strength reinforcing portion
2235: Column support protrusion 2250: Condenser sintered column
2255: Evaporator sintered base 2290: Air vent tube
2295: Air vent hole

### MODE FOR INVENTION

Hereinafter, a heat dissipation apparatus according to embodiments of the present disclosure will be described in detail with reference to the accompanying drawings.

It is to be noted that in assigning reference numerals to elements in the drawings, the same reference numerals denote the same elements as much as possible even in cases where the elements are shown in different drawings. Furthermore, in describing the embodiments of the present disclosure, a detailed description of the known configurations or functions will be omitted if it is deemed to obscure the understanding for the embodiments of the present disclosure.

In describing the elements of an embodiment of the present disclosure, terms, such as the first, the second, A, B, (a), and (b) may be used. However, the terms are used only to distinguish one element from the other element, and the essence, order, or sequence of the elements is not limited by the terms. Furthermore, unless otherwise defined, all terms used herein including technical or scientific terms have the same meanings as generally understood by those skilled in the art to which the present disclosure pertains. The terms, such as terms defined in dictionaries, which are generally used, should be construed as having meanings identical to contextual meanings of the related art, and are not construed as having ideal or excessively formal meanings unless they are definitely defined in the present disclosure.

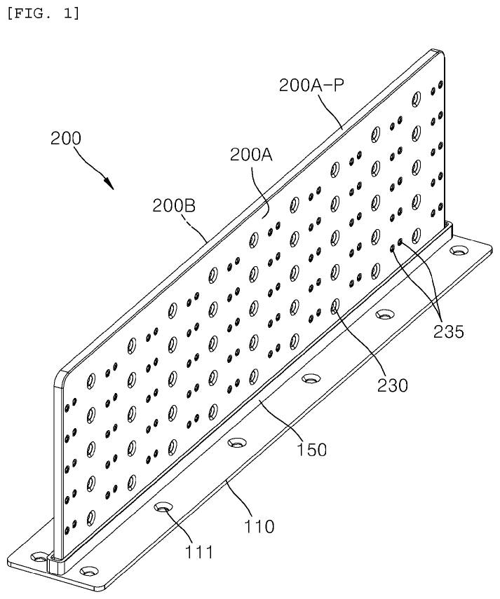

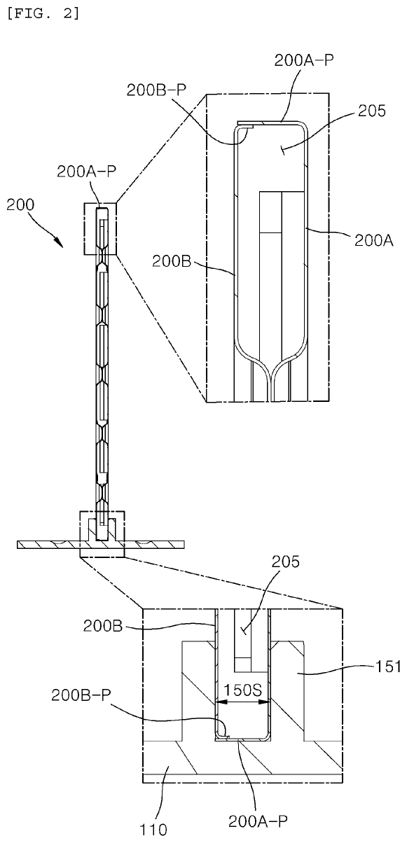

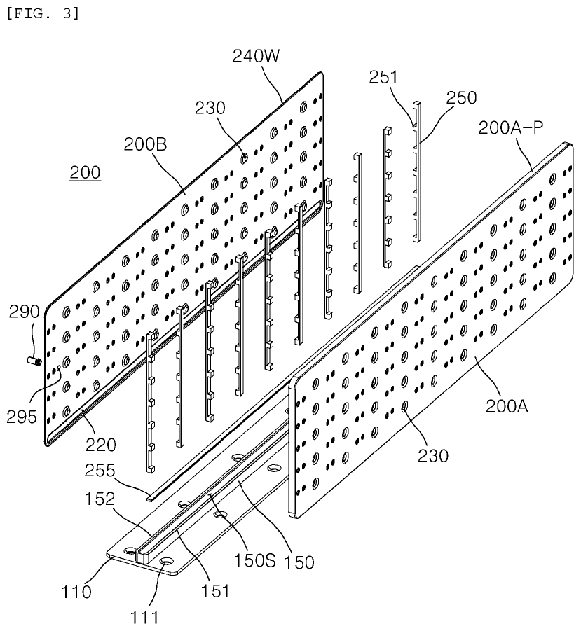

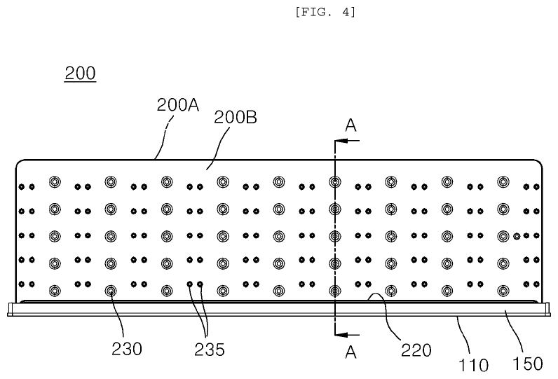

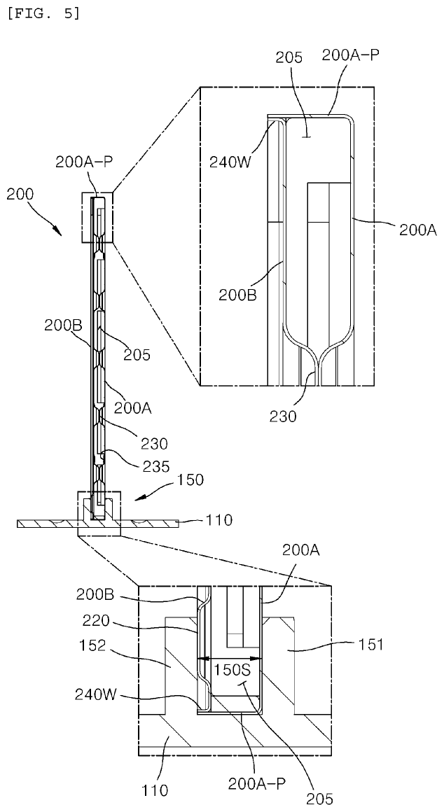

FIG. 1 is a perspective view illustrating a state in which a heat dissipation apparatus according to the present disclosure is installed in a press-fit portion of a housing body, FIG. 2 is a cross-sectional view taken along line A-A of FIG. 4 and a partially enlarged view thereof, showing a heat dissipation apparatus according to a first embodiment of the present disclosure, FIG. 3 is an exploded perspective view of FIG. 1, showing a heat dissipation apparatus according to a second embodiment of the present disclosure, FIG. 4 is a front view of FIG. 1, and FIG. 5 is a cross-sectional view taken along line A-A of FIG. 4 and a partially enlarged view thereof.

As shown in FIGS. 1 to 5, a heat dissipation apparatus 200 according to the first embodiment of the present disclosure includes a first-side heat-conducting panel 200A provided as a metal panel member, and a second-side heat-conducting panel 200B provided as a metal panel member.

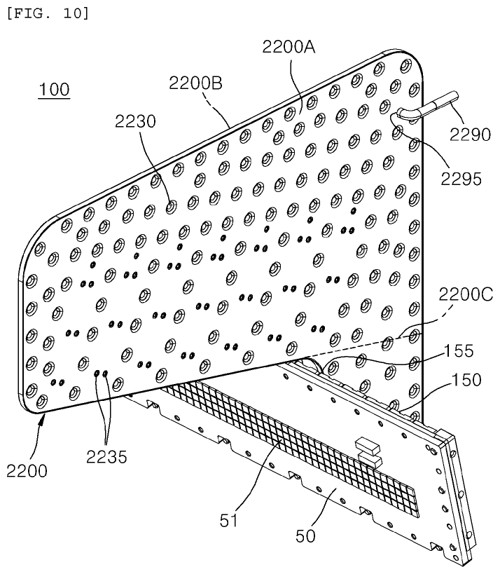

In particular, a portion corresponding to a space between the first-side heat-conducting panel 200A and the second-side heat-conducting panel 200B may form a refrigerant flow space 205 having a sealed structure with the outside, as will be described later, and a refrigerant may be filled therein so that the refrigerant may undergo a phase change within the refrigerant flow space 205 by heat supplied from external heat-generating elements (e.g., see reference numeral 51 of FIG. 10 described later), thereby dissipating system heat. This will be described in greater detail later.

Here, the first-side heat-conducting panel 200A and the second-side heat-conducting panel 200B may be made of the same metal material (metal panel material) having a thermal conductivity equal to or greater than a predetermined level.

Preferably, the panels may be made of at least stainless steel (SUS) among metal materials so that phase change of the refrigerant through heat exchange with outside air (outdoor air), particularly a phase change in which the refrigerant condenses from a vapor phase into a liquid phase, may be smoothly performed.

The specific reason for adopting the SUS material as the metal material forming the first-side heat-conducting panel 200A and the second-side heat-conducting panel 200B will be described in more detail later.

In addition, in the heat dissipation apparatus 200 according to a first embodiment of the present disclosure, the first-side heat-conducting panel 200A and the second-side heat-conducting panel 200B may be formed by sheet metal processing using a press forming process.

For reference, although the press forming process is not shown, it may be understood as a process in which a metal base panel made of SUS is subjected to the sheet metal processing through a press forming device so that at least respective edge portions are bonded to each other by a bonding medium frame body 280. At this time, through a press forming process, not only the outer shapes of the first-side heat-conducting panel 200A and the second-side heat-conducting panel 200B but also a plurality of strength reinforcing portions 230 to be described later may be simultaneously formed.

Here, the first-side heat-conducting panel 200A and the second-side heat-conducting panel 200B may be sheet metal processed products of a metal panel member made of SUS. The thicknesses of the first-side heat-conducting panel 200A and the second-side heat-conducting panel 200B are set to be very thin, and may be set to a thickness not exceeding 0.15 t.

In general, among metal materials, aluminum (Al) is well known as the most widely used material in terms of thermal conductivity and weight. Here, when a heat dissipation device itself, which substantially performs a heat dissipation or heat exchange function, has the form of heat sink fins and performs heat transfer solely through the material itself without using a phase-changeable refrigerant as a heat transfer medium as in an embodiment of the present disclosure, it is natural that aluminum be adopted as an optimal material.

That is, since aluminum has a very excellent thermal conductivity of 230 and has a low specific gravity, it is one of the most widely adopted materials as a heat dissipation element.

However, although aluminum has thermal conductivity and specific gravity superior to those of SUS, which is the material of the first-side heat-conducting panel 200A and second-side heat-conducting panel 200B adopted in an embodiment of the present disclosure (in fact, the thermal conductivity of SUS is 20), aluminum is relatively expensive in terms of cost, and when a refrigerant is filled therein, the type of refrigerant that may be filled is very limited.

For example, when distilled water (water) is adopted as the refrigerant, a chemical reaction occurs in the case of aluminum, making it impossible for the distilled water to function as the refrigerant, and thus there has been a problem in that distilled water should be excluded from the selectable refrigerant.

In order to solve the problems of aluminum, in the heat dissipation apparatus 200, 1200, or 2200 according to the present disclosure, the metal material of the first-side heat-conducting panel 200A and second-side heat-conducting panel 200B uses SUS that hardly causes a chemical reaction with distilled water.

The first-side heat-conducting panel 200A and the second-side heat-conducting panel 200B may be surface-bonded at edge portions thereof to each other to form the refrigerant flow space 205, in which the refrigerant undergoes a phase change and flows.

However, as described above, when edge portions of two metal panel members each having a very thin thickness (0.15 T) are joined to form the first-side heat-conducting panel 200A and the second-side heat-conducting panel 200B, the joined edge portions have a thickness of 0.3 T and may have very sharp edges unless additional processing is performed, thereby posing a risk that a worker may be injured during work.

In order to minimize injury to a worker during work as described above, in the heat dissipation apparatus 200 according to the first embodiment of the present disclosure, as shown in FIGS. 1 and 2, both the first-side heat-conducting panel 200A and the second-side heat-conducting panel 200B are formed such that their edge portions (see 200A-P and 200B-P in FIG. 2) are bent, and each bent edge portion forms a first-side thickness forming panel 200A-P and a second-side thickness forming panel 200B-P. A portion of the first-side thickness forming panel 200A-P of the first-side heat-conducting panel 200A and a portion of the second-side thickness forming panel 200B-P of the second-side heat-conducting panel 200B may be disposed to overlap in a thickness direction of the refrigerant flow space 205.

More specifically, as shown in FIG. 2, the first-side thickness forming panel 200A-P is a portion bent along the edge portion of the first-side heat-conducting panel 200A and may be bent to extend substantially perpendicular toward the second-side heat-conducting panel 200B, while the second-side thickness forming panel 200B-P is a portion bent along the edge portion of the second-side heat-conducting panel 200B and may be bent to extend substantially perpendicular toward the first-side heat-conducting panel 200A.

That is, the edge portion of the first-side heat-conducting panel 200A and the edge portion of the second-side heat-conducting panel 200B may be respectively bent in a direction forming the thickness of the refrigerant flow space 205, thereby forming the above-described first-side thickness forming panel 200A-P and second-side thickness forming panel 200B-P.

In the heat dissipation apparatus 200 according to the first embodiment of the present disclosure having the above configuration, as shown in FIG. 2, the first-side thickness forming panel 200A-P and the second-side thickness forming panel 200B-P may be arranged in parallel in the thickness direction of the refrigerant flow space 205 and may be arranged to overlap within the thickness region of the refrigerant flow space 205 so that surface-to-surface bonding is possible. By bonding portions where the surfaces are bonded to each other using a predetermined bonding method, the refrigerant filled therein may be sealed to prevent leakage to the outside.

However, in the heat dissipation apparatus 200 according to the first embodiment of the present disclosure, a front end of the second-side thickness forming panel 200B-P is bonded in a form in which it contacts an inner surface of the first-side thickness forming panel 200A-P and is not visible from the outside. However, the embodiment of the present disclosure is not necessarily limited thereto.

That is, in a heat dissipation apparatus 200 according to a modification of the first embodiment of the present disclosure, as shown in FIGS. 1 and 3 to 5, a bent edge portion of one of the first-side heat-conducting panel 200A and the second-side heat-conducting panel 200B may be arranged such that at least a portion thereof overlaps with a bent edge portion of the other on an outer side in the thickness direction of the refrigerant flow space 205 so as to enable surface-to-surface bonding.

At this time, one of the first-side heat-conducting panel 200A and the second-side heat-conducting panel 200B may be bonded so as to be inserted into the other. More specifically, the bent portion of the edge portion of the first-side heat-conducting panel 200A may form the thickness of the refrigerant flow space 205, and the bent portion of the edge portion of the second-side heat-conducting panel 200B may be bent in a direction opposite to a portion where the refrigerant flow space 205 is formed.

In the heat dissipation apparatus 200 according to a modification of the first embodiment of the present disclosure, the edge portion of the first-side heat-conducting panel 200A is inserted toward the edge portion of the second-side heat-conducting panel 200B, such that a thickness forming panel 200P and a bonding portion 240W corresponding to the respective edge portions may be bonded to each other.

More specifically, as shown in FIG. 1 and FIGS. 3 to 5, at the edge portion of the first-side heat-conducting panel 200A, which is an insertion target among the first-side heat-conducting panel 200A and the second-side heat-conducting panel 200B, a thickness forming panel 200A-P may be bent substantially perpendicular thereto.

Further, at the edge portion of the second-side heat-conducting panel 200B, which is inserted among the first-side heat-conducting panel 200A and the second-side heat-conducting panel 200B, a bonding portion 240W may be formed by bending so as to contact an inner side of the front end of the thickness forming panel 200A-P of the first-side heat-conducting panel 200A.

At this time, the front end of the thickness-forming panel 200A-P of the first-side heat-conducting panel 200A and the front end of the bonding portion 240W of the second-side heat-conducting panel 200B may be formed to correspondingly match each other. Thus, the portion including the bonding portion 240W of the second-side heat-conducting panel 200B may be inserted into the inner side of the thickness-forming panel 200A-P of the first-side heat-conducting panel 200A and then bonded thereto.

Inside a space between the first-side heat-conducting panel 200A and the second-side heat-conducting panel 200B bonded to each other as described above, the refrigerant flow space 205 is formed in which the refrigerant is filled and the filled refrigerant undergoes a phase change and flows. One end thereof may be inserted and fixed in a slot groove-shaped press-fit portion 150 formed in a housing portion 110 so as to be coupled to the heat-generating elements that supply heat to the filled refrigerant (heat-generating devices of an electronic device; see reference numeral 51 of FIG. 10 described later).

As shown in FIG. 5, the press-fit portion 150 may include a first-side press-fit portion 151 that contacts an outer surface corresponding to an evaporation end 201 (to be described later) of the first-side heat-conducting panel 200A, and a second-side press-fit portion 152 that contacts an outer surface corresponding to an evaporation end 201 (to be described later) of the second-side heat-conducting panel 200B. A space between respective inner surfaces of the first-side press-fit portion 151 and the second-side press-fit portion 152 may be defined as a press-fit slot 150S.

Here, among edge portions of the heat dissipation apparatus 200 in which the first-side heat-conducting panel 200A and the second-side heat-conducting panel 200B are bonded, a portion inserted into the press-fit portion 150 is defined as the evaporation end 201, and all remaining portions except for the evaporation end 201 are defined as a condensation end 203 for the purpose of description.

In the heat dissipation apparatus 200 according to a modification of the first embodiment of the present disclosure having the above configuration, the first-side heat-conducting panel 200A and the second-side heat-conducting panel 200B are bonded to each other through the thickness-forming panel 200A-P and the bonding portion 240W, respectively, in order to prevent the refrigerant from being spaced apart from the heat-generating elements by a sharply formed edge portion produced through sheet metal processing in a press forming process, and to prevent a worker from being injured by the sharp edge portion during insertion into or after installation in the press-fit portion 150.

Meanwhile, at the edge portion (i.e., the evaporation end 201) of the second-side heat-conducting panel 200B inserted into the press-fit slot 150S of the press-fit portion 150 having a slot-shaped groove arranged to transfer heat generated from the heat-generating elements, a contact surface portion 220 may be further formed to protrude outward from the refrigerant flow space 205 so as to contact the inner surface of the second-side press-fit portion 152 of the press-fit portion 150.

The contact surface portion 220 may serve to provide a contact area to enable coupling to the inner side of the second-side press-fit portion 152 of the press-fit portion 150 (i.e., an inner wall of the slot-shaped press-fit slot 150S) by a laser welding method or a brazing welding method. At this time, the contact surface portion 220 formed on the first-side heat-conducting panel 200A may be formed to be spaced apart from the bonding portion 240W.

However, the above-described welding coupling method is not necessarily limited to only one of the brazing welding process and the laser welding process.

For example, for bonding inside the refrigerant flow space 205, such as a plurality of strength reinforcement portions 230 described later, the brazing welding process is a more suitable coupling method. In contrast, for bonding the edge portions of the first-side heat-conducting panel 200A and the second-side heat-conducting panel 200B, the laser welding process is more suitable. Accordingly, the two processes may be used in combination.

Meanwhile, the plurality of strength reinforcing portions 230, which are formed by sheet metal processing during a press forming process so as to be recessed toward the refrigerant flow space 205, and a plurality of column support protrusions 235 for supporting installation of condenser sintered columns 250, which will be described later, may be respectively formed on the first-side heat-conducting panel 200A and the second-side heat-conducting panel 200B.

The plurality of strength reinforcing portions 230 not only perform the function of reinforcing the inherent strength of the first-side heat-conducting panel 200A and the second-side heat-conducting panel 200B, which are formed with a very thin thickness, but may also perform a function of 44 actively responding to internal pressure changes generated during phase change of the refrigerant by coupling portions contacting each other within the refrigerant flow space 205 through a welding method.

Here, the contact surface portion 220 formed at the edge portion of the second-side heat-conducting panel 200B may be formed to protrude in a direction opposite to the plurality of strength reinforcing portions 230 formed on the second-side heat-conducting panel 200B.

Meanwhile, as shown in FIGS. 1 to 3, the heat dissipation apparatus 200 according to the first embodiment of the present disclosure may further include the plurality of condenser sintered columns 250 disposed on the refrigerant flow space 205.

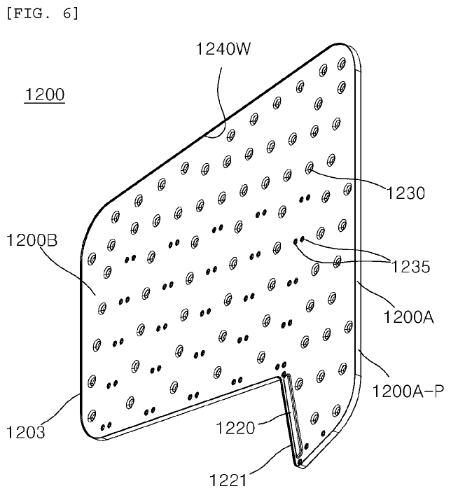

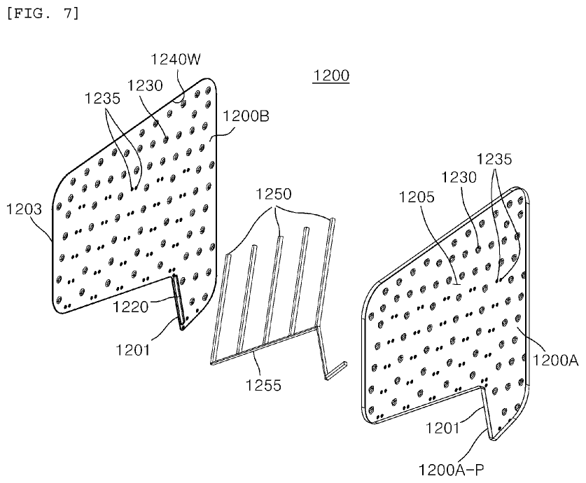

The plurality of condenser sintered columns 250 may be coupled to the inner surface of the thickness-forming panel 200B-P of the second-side heat-conducting panel 200B via an evaporator sintered base 255 connecting one ends thereof. Such a plurality of condenser sintered columns 250 may perform a function of guiding flow of liquid refrigerant condensed at the condensation end (see reference numeral 1203) in FIGS. 6 and 7, which will be described later), excluding the evaporation end (see reference numeral 1201) in FIGS. 6 and 7, which will be described later) of the first-side heat-conducting panel 200A and the second-side heat-conducting panel 200B installed at the press-fit portion 150, toward the evaporation end 201.

Here, the plurality of condenser sintered columns 250 and an evaporator sintered base 255 may be formed by sintering SUS powder. Hereinafter, since the plurality of condenser sintered columns 250 and the evaporator sintered base 255 to be described later differ only in characteristics (functions) contributing to the phase change of the refrigerant according to installation positions within the refrigerant flow space 205, their manufacturing method will be described on the assumption that they are the same.

Therefore, as described above, when it is understood that the first-side heat-conducting panel 200A and the second-side heat-conducting panel 200B are provided as metal panel members made of SUS, the plurality of condenser sintered columns 250 and the evaporator sintered base 255 may be understood as being formed by sintering metal powder of SUS so as to have the same thermal conductivity, although their forming or processing methods are somewhat different.

However, the plurality of condenser sintered columns 250 and the evaporator sintered base 255 are not necessarily required to be formed by sintering metal powder of SUS. In view of the fact that the evaporator sintered base is required to have a high thermal conductivity sufficient for causing liquid refrigerant to undergo phase change into vapor refrigerant by heat supplied from the heat-generating elements 51, the evaporator sintered base 255 may be formed as a sintered body obtained by sintering metal powder of Cu (copper).

Meanwhile, the first-side heat-conducting panel 200A and the second-side heat-conducting panel 200B may be stacked and bonded by a welding method. Here, the welding method may include either a general laser welding coupling method or a brazing welding coupling method.

Meanwhile, in the heat dissipation apparatus 200 according to the first embodiment of the present disclosure, each condenser sintered column 250 may be integrally formed with a plurality of support protrusions 251 which protrude to be supported on the inner surface of the first-side heat-conducting panel 200A and the inner surface of the second-side heat-conducting panel 200B.

More specifically, the condenser sintered column 250 may be sintered and formed in the shape of a quadrangular bar having four surfaces. One surface (hereinafter referred to as a “first surface”) may be supported or fixed so as to be in surface contact with the inner surface of one (hereinafter assumed as the first-side heat-conducting panel 200A) of the first-side heat-conducting panel 200A and the second-side heat-conducting panel 200B, and front end surfaces of the plurality of support protrusions 251 may be formed on a surface (hereinafter referred to as a “second surface”) facing the first surface of the condenser sintered column 250 so as to be supported or fixed in surface contact with the inner surface of the second-side heat-conducting panel 200.

Such a condenser sintered column 250 is configured such that the first surface thereof is supported on the inner surface of the first-side heat-conducting panel 200A, and the front end surfaces of the plurality of support protrusions 251 formed on the second surface thereof are supported on the inner surface of the second-side heat-conducting panel 200B. This reinforces the rigidity of the first-side heat-conducting panel 200A and the second-side heat-conducting panel 200B, which are formed with a relatively thin thickness (0.15 T), and prevents the movement of the first-side heat-conducting panel 200A and the second-side heat-conducting panel 200B, which may be shaken or displaced due to changes in internal pressure of the refrigerant flow space 205 during the phase change of the refrigerant. Therefore, energy involved in the phase change of the refrigerant is prevented from being converted into physical energy unrelated to heat dissipation, thereby improving heat dissipation performance.

Further, the vapor refrigerant or the liquid refrigerant may smoothly flow through the spaces between the plurality of support protrusions 251, thereby allowing vapor-liquid circulation to be evenly and uniformly distributed without being biased to one side.

Meanwhile, the first-side heat-conducting panel 200A and the second-side heat-conducting panel 200B may further be provided with the plurality of column support protrusions 235 that support installation of the plurality of condenser sintered columns 250.

Likewise, it is natural that the contact surface portion 220 formed at the edge portion of the second-side heat-conducting panel 200B may be defined as being formed to protrude in a direction opposite to the plurality of support protrusions 251 formed on the second-side heat-conducting panel 200B.

Meanwhile, an air vent hole 295 to which an air vent tube 290 is connected may be formed in either of the first-side heat-conducting panel 200A or the second-side heat-conducting panel 200B (in another embodiment of the present disclosure, the second-side heat-conducting panel 200B corresponds thereto).

The air vent tube 290 may be installed in the air vent hole 295, such that a vacuumizing process of the refrigerant flow space 205 may be performed through the air vent tube 290 before filling the refrigerant or after filling the refrigerant.

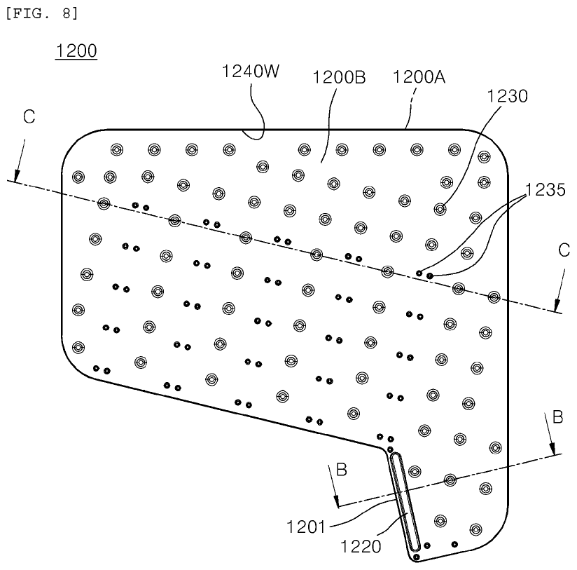

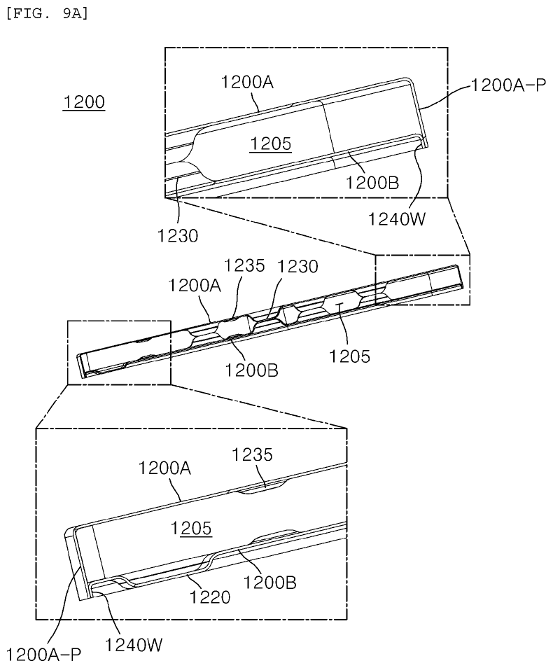

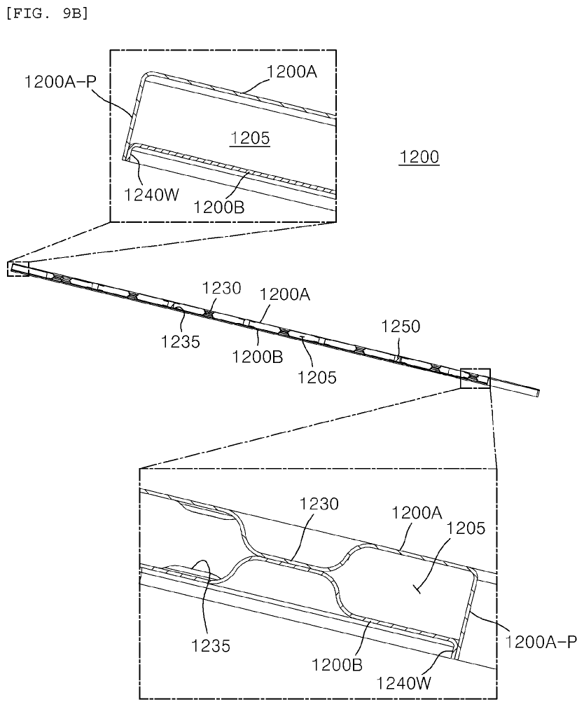

FIG. 6 is a perspective view illustrating a heat dissipation apparatus according to a second embodiment of the present disclosure, FIG. 7 is an exploded perspective view of FIG. 6, FIG. 8 is a front view of FIG. 6, and FIGS. 9A and 9B are cross-sectional views taken along lines B-B and C-C of FIG. 8, respectively, and partially enlarged views thereof.

The heat dissipation apparatus 200 according to the first embodiment of the present disclosure and the modification thereof described with reference to FIGS. 1 to 5 has been explained on the assumption that the first-side heat-conducting panel 200A and the second-side heat-conducting panel 200B are formed in a substantially rectangular shape. However, it should be noted that the overall external shape forming the heat dissipation apparatus is not necessarily limited to a rectangular shape in manufacturing.

For example, as shown in FIGS. 6 to 9B, a heat dissipation apparatus 1200 according to a second embodiment of the present disclosure may be formed in various shapes according to an arrangement of heat-generating elements to which it is directly applied and an external shape of an electronic device product.

In this way, the heat dissipation apparatus 1200 according to the second embodiment of the present disclosure may differ from the heat dissipation apparatus 200 according to the first embodiment of the present disclosure and a modification thereof described above only in terms of its external appearance (external shape), while the other components may be configured to perform the same functions.

More specifically, in the heat dissipation apparatus 1200 according to the second embodiment of the present disclosure, refrigerant flow space 1205 in which refrigerant flows while undergoing phase change is also formed between the first-side heat-conducting panel 1200A and the second-side heat-conducting panel 1200B. Among outer ends of the first-side heat-conducting panel 1200A and the second-side heat-conducting panel 1200B, a specific portion corresponding to a region close to the heat-generating elements is defined as a portion performing a function corresponding to the above-described evaporation end 1201, and the remaining outer ends other than the evaporation end 1201 are defined as portions performing a function corresponding to a condensation end 1203. This is the same as in the heat dissipation apparatus 200 according to the first embodiment of the present disclosure and the modification thereof.

That is, in the case of the heat dissipation apparatus 200 according to the first embodiment of the present disclosure and the modification thereof described above, the external shape is formed in the rectangular shape such that one long side (reference numeral not shown) corresponding to a long side thereof serves as the evaporation end (see reference numeral 2201 in FIG. 10 and the following drawings, which will be described later) connected close to the heat-generating elements. In contrast, in the heat dissipation apparatus 1200 according to the second embodiment of the present disclosure, only a portion of an edge portion corresponds to the evaporation end connected close to the heat-generating elements, which are targets that substantially receive heat, while the remaining portions are designed to serve as the condensation end (see reference numeral 2203 in FIG. 10 and the following drawings, which will be described later).

Further, as shown in FIGS. 6 to 9B, in the heat dissipation apparatus 1200 according to the second embodiment of the present disclosure, a plurality of strength reinforcing portions 1230, which are formed by sheet metal processing during a press forming process so as to be recessed toward the refrigerant flow space 1205, and column support protrusions 1235 for supporting installation of condenser sintered columns 1250 may be respectively formed on the first-side heat-conducting panel 1200A and the second-side heat-conducting panel 1200B.

Here, the column support protrusions 1235 are arranged and designed to be spaced apart by approximately a width of a pair of condenser sintered columns 1250, such that, when the first-side heat-conducting panel 1200A and the second-side heat-conducting panel 1200B are bonded to each other, both ends of the condenser sintered columns 1250 in the width direction are simultaneously supported from both inner sides of the refrigerant flow space 1205, thereby stably supporting the condenser sintered columns 1250, which are sintered bodies that are relatively fragile.

It has already been described that the plurality of strength reinforcing portions 1230 not only perform a function of reinforcing the inherent strength of the first-side heat-conducting panel 1200A and the second-side heat-conducting panel 1200B, which are formed with a very thin thickness, but also may perform a function of actively responding to internal pressure changes o generated during phase change of the refrigerant by coupling portions contacting each other within the refrigerant flow space 1205 through a welding method.

Here, it is natural that a contact surface portion 1220 may be further processed and formed at an edge portion of the first-side heat-conducting panel 1200A corresponding to the evaporation end 1201, which is a portion inserted into the press-fit portion 150, so as to protrude outward of the refrigerant flow space 1205 and contact the inner surface of the press-fit portion 150.

In addition, also in the heat dissipation apparatus 1200 according to the second embodiment of the present disclosure, a bonding portion 1240W provided on the second-side heat-conducting panel 1200B is disposed to be in surface contact with an inner surface of a thickness-forming panel 1200A-P provided on the first-side heat-conducting panel 1200A, and the refrigerant flow space 1205 is formed therein by mutually bonding the surfaces, which will have the same technical principle as that of the heat dissipation apparatus 200 according to the first embodiment of the present disclosure and the modification thereof already described.

FIG. 10 is a perspective view illustrating an application example of a heat dissipation apparatus according to a third embodiment of the present disclosure.

As shown in FIG. 10, a heat dissipation apparatus 2200 according to a third embodiment of the present disclosure may be provided to receive heat generated from an electronic device 50 (e. g., an LED unit) on which heat-generating devices 51 (e.g., LED devices in a lighting device), which are targets to be cooled, are mounted, and to dissipate the heat through heat exchange with outside air (outdoor air).

Here, although the electronic device, which is a heat dissipation target dissipated by the heat dissipation apparatus 2200 according to the third embodiment of the present disclosure, is described as being limited to the LED unit 50 including the LED devices 51, the electronic device is not necessarily limited thereto, and electronic devices related to an antenna device or other technical fields having a similar technical scope, which correspond to the main technical field of the applicant of the present disclosure, are not excluded.

The LED unit 50 transfers and supplies heat generated from the LED devices (i.e., heat-generating elements 51) to the heat dissipation apparatus 2200 according to the third embodiment of the present disclosure through a rear surface thereof in FIG. 10.

However, in order to facilitate installation on the rear surface of the LED unit 50 and heat transfer to the heat dissipation apparatus 2200, a plurality of heat transfer medium blocks may be installed between the LED unit 50 and the heat dissipation apparatus 2200 based on the same principle as the above-described press-fit portion 150, and an evaporation end 2201, which will be described later, of the heat dissipation apparatus 2200 may be coupled through installation grooves 155 formed between the plurality of heat transfer medium blocks or in the blocks themselves.

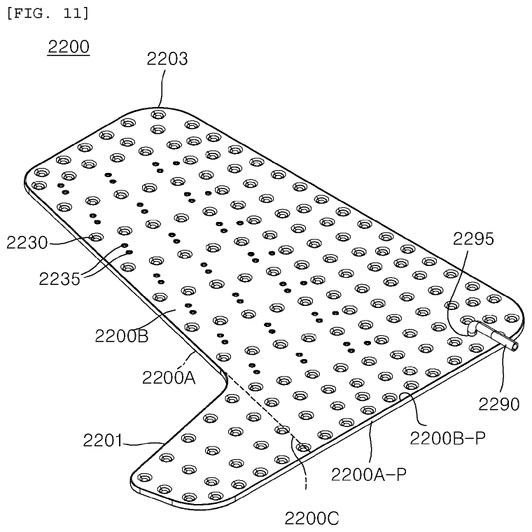

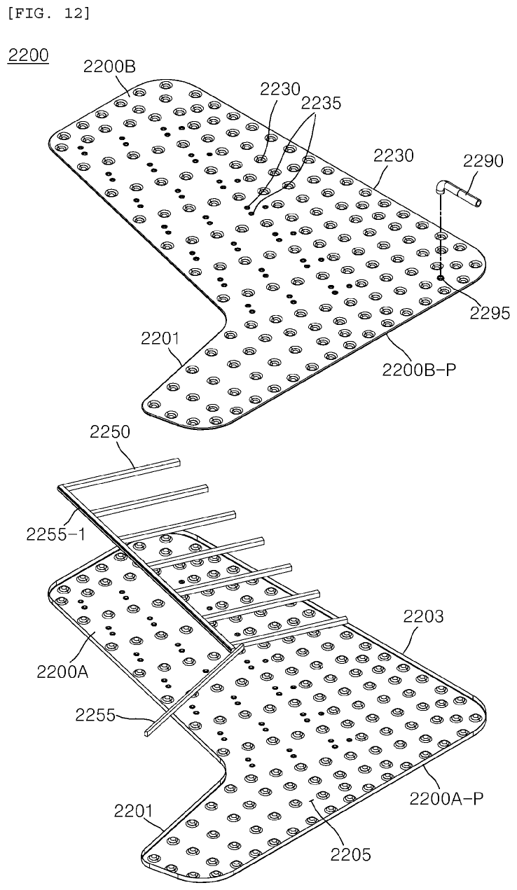

FIG. 11 is a perspective view illustrating a heat dissipation apparatus according to the third embodiment of the present disclosure, and FIG. 12 is an exploded perspective view of FIG. 11.

Similarly to the heat dissipation apparatus 1200 according to the second embodiment of the present disclosure described above, in the heat dissipation apparatus 2200 according to the third embodiment of the present disclosure, as shown in FIGS. 11 and 12, the first-side heat-conducting panel 2200A and the second-side heat-conducting panel 2200B may be sheet-metal processed through a press forming process as metal panel members having a thermal conductivity equal to or greater than a predetermined level.

Here, the first-side heat-conducting panel 2200A and the second-side heat-conducting panel 2200B are sheet-metal processed products of metal panel members made of SUS. Even when respective edge portions of the first-side heat-conducting panel 2200A and the second-side heat-conducting panel 2200B are surface-bonded to form a sealed (shielded) refrigerant flow space 2205 therein, a sum of their thicknesses is about 0.3 t, resulting in a very sharp edge portion. Thus, in order to minimize a risk of injury to an installer due to the sharp edge portion during work, the design may be modified to increase a product thickness by a thickness-forming panel 2200A-P, which will be described later.

At this time, one of the first-side heat-conducting panel 2200A and the second-side heat-conducting panel 2200B may be bonded so as to be inserted into the other. In the heat dissipation apparatus 2200 according to the third embodiment of the present disclosure, a structure is adopted in which a second-side thickness-forming panel 2200B-P of the second-side heat-conducting panel 2200B is inserted in a thickness direction defined by the first-side thickness-forming panel 2200A-P of the first-side heat-conducting panel 2200A, which will be described later.

More specifically, the second-side heat-conducting panel 2200B may be bent such that a portion corresponding to an edge portion is inserted with respect to the first-side heat-conducting panel 2200A, and the second-side thickness-forming panel 2200B-P may be bent and formed such that a front end thereof is bonded while being concealed from the outside by the first-side heat-conducting panel 2200A.

Further, the first-side thickness-forming panel 2200A-P may be bent and formed on the first-side heat-conducting panel 2200A so as to extend orthogonally, thereby enabling surface bonding with the second-side thickness-forming panel 2200B-P of the second-side heat-conducting panel 2200B.

Here, the second-side heat-conducting panel 2200B is bonded so as to be inserted with respect to the first-side heat-conducting panel 2200A, and the second-side thickness-forming panel 2200B-P including the front end of the second-side heat-conducting panel 2200B is inserted into and bonded to the first-side thickness-forming panel 2200A-P of the first-side heat-conducting panel 2200A, such that the front end of the second-side thickness-forming panel 2200B-P is concealed from the outside.

For this purpose, the first-side thickness-forming panel 2200A-P of the first-side heat-conducting panel 2200A may be bent and formed orthogonally so as to be surface-bonded to an outer surface of the second-side thickness-forming panel 2200B-P of the second-side heat-conducting panel 2200B.

Here, as the first-side thickness-forming panel 2200A-P of the first-side heat-conducting panel 2200A performs a function as a thickness-forming panel that defines an overall thickness of the refrigerant flow space 2205, it may perform an additional function of preventing injury to a worker (including an assembler) by eliminating a sharp edge portion during work.

Inside a space between the first-side heat-conducting panel 2200A and the second-side heat-conducting panel 2200B bonded to each other as described above, the refrigerant flow space 2205 is formed in which refrigerant is filled and flows while undergoing phase change, and the panels may be in surface thermal contact with the heat-generating elements 51 that supply heat to the filled refrigerant.

The refrigerant filled in the refrigerant flow space 2205 corresponds to a phase change material that may undergo phase change by heat supplied from the heat-generating elements 51 or through heat exchange with outside air (outdoor air). In particular, the refrigerant used herein is preferably distilled water (water), which does not cause environmental pollution, when the metal material forming the first-side heat-conducting panel 2200A and the second-side heat-conducting panel 2200B excludes aluminum (Al).

Meanwhile, among the edge portions of the heat dissipation apparatus 2200 according to the third embodiment of the present disclosure, in which the first-side heat-conducting panel 2200A and the second-side heat-conducting panel 2200B are bonded, a portion that receives heat from the heat-generating elements 51 is defined as an evaporation end 2201, and all remaining portions except for the evaporation end 2201 are defined as a condensation end 2203.

Here, as shown in FIGS. 11 and 12, the heat dissipation apparatus 2200 according to the third embodiment of the present disclosure may further include condenser sintered columns 2250 disposed on the refrigerant flow space 2205.

Meanwhile, the refrigerant flow space 2205 may be understood such that a portion corresponding to a relatively lower position in a gravity direction serves as a region (evaporation region) where liquid refrigerant is stored and evaporates into vapor refrigerant upon receiving heat, and a portion corresponding to a relatively upper position in the gravity direction serves as a region (condensation region) where vapor refrigerant actively flows and is condensed into liquid refrigerant through heat exchange with outside air (outdoor air).

Hereinafter, the evaporation region and the condensation region will be understood as being distinguished based on a dotted line denoted by reference numeral 2200C in FIG. 11. Most of the liquid refrigerant is stored below the dotted line 2200C due to gravity, while the vapor refrigerant, once it undergoes phase change from the liquid refrigerant, flows and diffuses to all portions of the refrigerant flow space 2205 including the evaporation region, regardless of the dotted line 2200C.

Further, a portion corresponding to a lower side in the gravity direction with respect to reference numeral 2200C is defined as the evaporation region, that is, an evaporation end 2201, and a portion corresponding to an upper side in the gravity direction with respect to reference numeral 2200C is defined as the condensation region, that is, a condensation end 2203.

Here, a plurality of condenser sintered columns 2250 are arranged to be spaced apart and inclined within the region of the condensation end 2203, and respective lower ends of the plurality of condenser sintered columns 2250 in the gravity direction may be connected by an evaporator sintered base 2255.

The condenser sintered columns may be coupled to an inner surface of the thickness-forming panel 200B-P of the second-side heat-conducting panel 200B via the evaporator sintered base 255 connecting lower ends of a plurality of guide sintered bars 251.

Here, although the evaporator sintered base 2255 is preferably formed only on the evaporation end 2201 side, in the heat dissipation apparatus 2200 according to the third embodiment of the present disclosure, a sintered additional base 2255-1 may be further provided that further extends toward an end side of the condensation end 2203, which corresponds to a lower end of the condensation end 2203 in the gravity direction and corresponds to an upper side of the evaporation end 2201.

When the plurality of condenser sintered columns 2250 are arranged such that liquid refrigerant condensed in a region corresponding to the condensation end 2203 naturally flows downward due to gravity, the condenser sintered columns may be arranged vertically or inclined such that upper ends thereof are positioned on an upper side in the gravity direction and lower ends thereof are positioned on a lower side in the gravity direction.

Here, the sintered additional base 2255-1 may enable the liquid refrigerant condensed downward in the gravity direction through the plurality of condenser sintered columns 2250 to be easily collected in a region corresponding to the evaporation end 2201 when guided to flow downward.

The evaporator sintered base 2255 is installed at a portion of the evaporation end 2201 that is substantially closest to the heat-generating elements 51, and serves to directly receive heat from the heat-generating elements 51, thereby evaporating the liquid refrigerant.

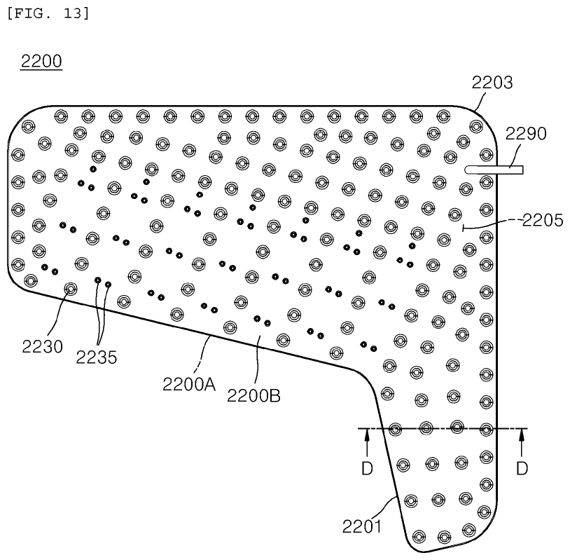

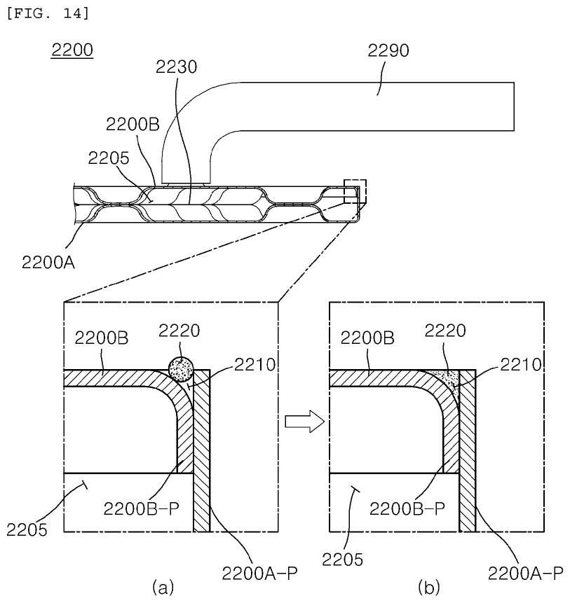

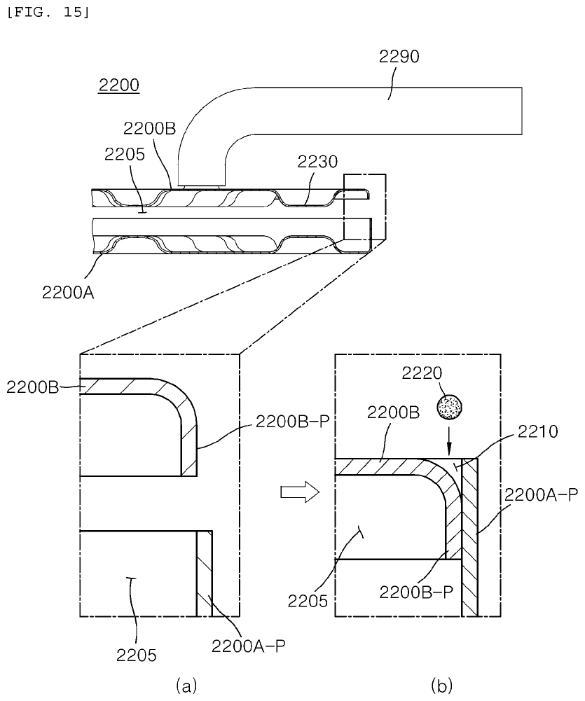

FIG. 13 is a front view of FIG. 11, FIG. 14 is a cross-sectional view taken along line D-D of FIG. 13 and a partially enlarged view for explaining a bonded state by a filler material, and FIG. 15 is an exploded cross-sectional view taken along line D-D of FIG. 13 and a partially enlarged view for explaining a bonded state by a filler material.

In the heat dissipation apparatus 2200 according to the third embodiment of the present disclosure, as shown in FIGS. 13 to 15, a rounded outer surface of the second-side thickness-forming panel 2200B-P, which will be described later, as a portion corresponding to the edge portion of the second-side heat-conducting panel 2200B, and a front end of the first-side thickness-forming panel 2200A-P as a portion corresponding to the edge portion of the first-side heat-conducting panel 2200A may be bonded by a filler material 2220 applied to a filler material application gap 2210 defined therebetween.

In order to form the filler material application gap 2210 as described above, the outer surface of the second-side heat-conducting panel 2200B and the front end of the first-side thickness-forming panel 2200A-P of the first-side heat-conducting panel 2200A may be formed so as to match each other.

More specifically, the second-side thickness-forming panel 2200B-P of the second-side heat-conducting panel 2200B may be bent to have a rounded shape with a predetermined radius with respect to the outer surface of the second-side heat-conducting panel 2200B, such that the above-described filler material application gap 2210 is defined between the second-side thickness-forming panel and the front end of the first-side thickness-forming panel 2200A-P of the first-side heat-conducting panel 2200A.

Here, the filler material application gap 2210 may be defined as a gap between the front end of the first-side thickness-forming panel 2200A-P, which is bent perpendicularly with respect to the outer surface of the first-side heat-conducting panel 2200A, and the outer surface of the second-side heat-conducting panel 2200B.

When the second-side heat-conducting panel 2200B is installed so as to be inserted with respect to the first-side heat-conducting panel 2200A, as shown in FIGS. 14 and 15, the filler material application gap 2210, to which the filler material 2220 may be applied, is naturally formed between the rounded outer surface of the second-side thickness-forming panel 2200B-P of the second-side heat-conducting panel 2200B and the front end of the first-side thickness-forming panel 2200A-P of the first-side heat-conducting panel 2200A. After the filler material 2220 is applied, the filler material 2220 is melted and permeated by a brazing welding process and then hardened, thereby bonding the first-side heat-conducting panel 2200A and the second-side heat-conducting panel 2200B.

Unexplained reference numeral 2290 denotes an air vent tube, and reference numeral 2295 denotes an air vent hole.

As described above, a heat dissipation apparatus according to embodiments of the present disclosure has been described in detail with reference to the accompanying drawings. However, embodiments of the present disclosure are not necessarily limited to the above-described embodiments, and it will be apparent that various modifications and equivalent implementations are possible by those skilled in the art. Therefore, the true scope of the present disclosure is defined by the claims set forth below.

### INDUSTRIAL APPLICABILITY

The present disclosure provides a heat dissipation apparatus in which heat dissipation performance can be maximized and productivity can be improved.

1. A heat dissipation apparatus comprising:
a first-side heat-conducting panel provided as a metal panel member; and
a second-side heat-conducting panel provided as a metal panel member,
wherein the first-side heat-conducting panel and the second-side heat-conducting panel have bent edge portions that are surface-bonded to each other to define a refrigerant flow space in which a refrigerant flows while undergoing phase change, and
wherein the bent edge portion of one of the first-side heat-conducting panel and the second-side heat-conducting panel is arranged such that at least a portion thereof overlaps in a thickness direction of the refrigerant flow space with the bent edge portion of the other so as to enable the mutual surface bonding.

2. The heat dissipation apparatus of claim 1, wherein the edge portion of the first-side heat-conducting panel and the edge portion of the second-side heat-conducting panel are each bent in a direction forming a thickness of the refrigerant flow space.

3. The heat dissipation apparatus of claim 2,
wherein the bent edge portion of the first-side heat-conducting panel is a first-side thickness-forming panel forming a portion of the thickness of the refrigerant flow space, and
wherein the bent edge portion of the second-side heat-conducting panel is a second-side thickness-forming panel forming a portion of the thickness of the refrigerant flow space.

4. A heat dissipation apparatus comprising:
a first-side heat-conducting panel provided as a metal panel member; and
a second-side heat-conducting panel provided as a metal panel member,
wherein the first-side heat-conducting panel and the second-side heat-conducting panel have bent edge portions that are surface-bonded to each other to define a refrigerant flow space in which a refrigerant flows while undergoing phase change, and
wherein the bent edge portion of one of the first-side heat-conducting panel and the second-side heat-conducting panel is arranged such that at least a portion thereof overlaps with the bent edge portion of the other on an outer side in a thickness direction of the refrigerant flow space so as to enable the mutual surface bonding.

5. The heat dissipation apparatus of claim 4,
wherein a thickness-forming panel is orthogonally bent and provided at the edge portion of the second-side heat-conducting panel, which is an insertion target among the first-side heat-conducting panel and the second-side heat-conducting panel, and
wherein a bonding portion bent to contact an inner side of a front end of the thickness-forming panel of the second-side heat-conducting panel is formed at the edge portion of the first-side heat-conducting panel, which is inserted among the first-side heat-conducting panel and the second-side heat-conducting panel.

6. The heat dissipation apparatus of claim 5, wherein a contact surface portion is further processed and formed at an edge portion of the first-side heat-conducting panel that is inserted into a press-fit portion having a slot-shaped press-fit slot disposed to transfer heat generated from heat-generating elements, such that the contact surface portion protrudes outward of the refrigerant flow space to contact an inner surface of the press-fit portion.

7. The heat dissipation apparatus of claim 6, wherein the contact surface portion formed on the first-side heat-conducting panel is formed to be spaced apart from the bonding portion.

8. The heat dissipation apparatus of claim 6,
wherein a plurality of strength reinforcing portions recessed toward the refrigerant flow space are further formed on the first-side heat-conducting panel and the second-side heat-conducting panel, and
wherein the contact surface portion is formed to protrude in a direction opposite to the plurality of strength reinforcing portions formed on the second-side heat-conducting panel.

9. The heat dissipation apparatus of claim 5, wherein, when an end of each of the first-side heat-conducting panel and the second-side heat-conducting panel that are relatively close to the heat-generating elements generating and supplying predetermined heat is defined as an evaporation end, and portions other than the evaporation end are defined as a condensation end,
the heat dissipation apparatus further comprises:
a plurality of condenser sintered columns disposed on the refrigerant flow space and configured to guide flow of liquid refrigerant condensed at the condensation end, excluding the evaporation end of the first-side heat-conducting panel and the second-side heat-conducting panel installed at the press-fit portion, toward the evaporation end.

10. The heat dissipation apparatus of claim 9, wherein the plurality of condenser sintered columns are installed in the refrigerant flow space via an evaporator sintered base connecting one ends thereof.

11. The heat dissipation apparatus of claim 9,
wherein a plurality of column support protrusions supporting installation of the plurality of condenser sintered columns are further formed on the first-side heat-conducting panel and the second-side heat-conducting panel, and
wherein the contact surface portion is formed to protrude in a direction opposite to the plurality of column support protrusions formed on the first-side heat-conducting panel.

12. A heat dissipation apparatus comprising:
a first-side heat-conducting panel provided as a metal panel member; and
a second-side heat-conducting panel provided as a metal panel member and forming, together with the first-side heat-conducting panel, a refrigerant flow space in which a refrigerant flows while undergoing phase change,
wherein the second-side heat-conducting panel comprises a second-side thickness-forming panel bent to be inserted into the first-side heat-conducting panel, a front end of which is bonded while being concealed from the outside by the first-side heat-conducting panel.

13. The heat dissipation apparatus of claim 12, wherein the first-side heat-conducting panel comprises a first-side thickness-forming panel bent and formed orthogonally so as to be surface-bonded to the second-side thickness-forming panel of the second-side heat-conducting panel.

14. The heat dissipation apparatus of claim 13, wherein an outer surface of the second-side heat-conducting panel and a front end of the first-side thickness-forming panel of the first-side heat-conducting panel are formed to match each other.

15. The heat dissipation apparatus of claim 13, wherein the second-side thickness-forming panel of the second-side heat-conducting panel is bent to have a rounded shape with a predetermined radius with respect to the outer surface of the second-side heat-conducting panel, such that a filler material application gap is defined between the second-side thickness-forming panel and the front end of the first-side thickness-forming panel of the first-side heat-conducting panel.

16. The heat dissipation apparatus of claim 15, wherein the filler material application gap is defined as a gap between the front end of the first-side thickness-forming panel, which is bent perpendicularly with respect to an outer surface of the first-side heat-conducting panel, and the outer surface of the second-side heat-conducting panel.

17. The heat dissipation apparatus of claim 15, wherein a filler material that melts at or above a predetermined melting point is applied to the filler material application gap.

18. The heat dissipation apparatus of claim 17, wherein the filler material, after being applied to the filler material application gap, bonds the first-side heat-conducting panel and the second-side heat-conducting panel by a brazing welding process.

19. The heat dissipation apparatus of claim 1, wherein the first-side heat-conducting panel and the second-side heat-conducting panel are provided as metal panel members made of SUS.

20. The heat dissipation apparatus of claim 1, wherein the first-side heat-conducting panel and the second-side heat-conducting panel are stacked and bonded by a laser welding method or a brazing welding method.

21. The heat dissipation apparatus of claim 9, wherein the plurality of condenser sintered columns and the evaporator sintered base are formed by sintering SUS powder.

22. The heat dissipation apparatus of claim 21, wherein the plurality of condenser sintered columns and the evaporator sintered base are formed by sintering metal powder having the same material as that of the metal panel members of the first-side heat-conducting panel and the second-side heat-conducting panel.

23. The heat dissipation apparatus of claim 22, wherein a material of the metal powder of the plurality of condenser sintered columns and the evaporator sintered base is SUS.

24. The heat dissipation apparatus of claim 22, wherein the evaporator sintered base is formed by sintering metal powder made of copper (Cu).

25. The heat dissipation apparatus of claim 1, wherein the first-side heat-conducting panel and the second-side heat-conducting panel are made of the same metal material or different metal materials having a thermal conductivity equal to or greater than a predetermined level.

26. The heat dissipation apparatus of claim 1, wherein the first-side heat-conducting panel and the second-side heat-conducting panel are sheet-metal processed through a press forming process.
